(19) United States
(12) Patent Application Publication
(10) Pub. No.: US 2002/0120670 A1
(43) Pub. Date: Aug. 29, 2002

(54) System and method for communications between computer systems and peripheral devices

(76) Inventor: Hui-ling Chou, Hsinchu (TW)

Correspondence Address: BACON & THOMAS, PLLC, 625 Slaters Lane, 4th Floor, Alexandria, VA, 22314-1176, US

(21) Appl. No.: 09/793,548

(22) Filed: Feb. 27, 2001

(51) Int. Cl. G06F 15/16

(52) U.S. Cl. 709/201

(57) ABSTRACT

A system and method employed for communications between a computer system and a peripheral device is disclosed. In one embodiment, the computer system downloads real-time information such as e-mail address books or fax number books to the peripheral device, e.g., a scanner, if the connection between them is successfully established. The scanner shows the real-time information listed in a LCD to provide references to an individual, whereas the individual may select one, e.g., an e-mail address or a fax number, from the shown list. An individual may activate e-mail or facsimile functions by pressing associated buttons when completing selections. The scanner activates associate scan operations to derive scanned images by scanning document sheets and then forwards the scanned images to the computer system for further manipulation. The computer system finally activates associated application to fax or e-mail the scanned images to destinations indicated by the individual.

### BACKGROUND OF THE INVENTION

1. Field of the Invention

The present invention relates to a system and method for communications between a computer system and a peripheral device. More specifically, the present invention relates to a system and method for downloading real-time information from the computer system for reference to an individual when makes selections and then activates consecutive operations after the connection between the computer system and the peripheral device being successfully established.

In a specific application, the present invention relates to a system and method for downloading real-time information from a computer system to show to an individual so that the peripheral device may generate and forward images to the computer system to activate the operations indicated by the individual.

In a still further application, the present invention relates to a system and method for an information appliance to download and display real-time information from the computer system so that an individual may give further indications in the peripheral devices by means of friendly interfaces.

2. Description of the Prior Art

The prosperity of the electrical engineering upgrades the performances and functions provided by the computer peripheral devices. For example, the manufacturers of scanners continuously upgrade resolutions and color display performances of their scanners. However, they should have to make their scanners to be capable of activating a printer for copying scanned images or starting a facsimile machine for faxing scanned images to indicated destinations. An individual should turn his/her scanner power on and then make the scanner to successfully connect with a computer system firstly. He/She may press the scan button in the scanner or in the user interfaces provided by the scanner manufacturer and shown in the display of the computer system for starting scan operations. Those operating sequences are usually complicated and massy. For an individual, he/she should be familiar with the computer system and scanner to achieve his/her requirements when operating in the aforementioned user interfaces. Additionally, the scanned images must be transferred from the scanner to the computer system via a connection between them, whereas the individual may then activate associated applications to e-mail or fax the scanned images to people else. It is quite a difficult job for those people who are out of practice on computer systems or scanners to complete the aforementioned operating sequences. Additionally, for information appliances which concentrate people's attentions these days, to provide a friendly user interface becomes an essential requirement. The conventional peripheral devices, which obviously lack friendly user interfaces for operations, significantly have to improve themselves before becoming members of the information appliances.

### SUMMARY OF THE INVENTION

The principal object of the invention is to provide a system and method for a peripheral device that may download and display real-time information to an individual for indication to consecutive operations after a connection between the peripheral device and a computer system is successfully established.

The other object of the invention is to provide a system and method for a peripheral device that may download and display real-time information from a computer system. Images generated by the peripheral device are forwarded to and manipulated by the computer system according to the indications of the individual.

A still further object of the invention is to provide a system and method for an information appliance to download and display real-time information from the computer system in order to make an individual to determine following operations by mean of friendly user interfaces without perplexity.

In one embodiment, when a connection between a computer system and a scanner is successfully established, the computer system downloads e-mail address books or fax number books to the scanner. The scanner then shows the real-time downloaded books and wait for indications from an individual. For the individual, he/she may successively press an e-mail button or a fax button of the scanner to respectively activate e-mailing or faxing operations. The scanner thus derives scanned images by scanning document sheets, while the scanned images are then forwarded to the computer system for manipulations according to the aforementioned indications. Associated applications are then activated by the computer system to e-mail or fax the scanned images to destinations indicated by the individual.

In the embodiment, a resident module of the scanner basically encompasses a command interpretation module, a user interface information module, a computer resource inquisition module, a connection status detection module, and a real-time information downloading module. Command interpretation module stores programs operated by the processing device of the computer system to interpret commands, such as commands indicative of faxing or e-mailing scanned images, given by the individual from the scanner or the computer system. User interface information module stores resource codes for associated graphic interfaces, such as codes for indicating graphics or icons, when the individual activates interfaces in the computer system. Computer resource inquisition module stores programs operated by the processing device of the computer system to inquire currently mounted applications. Connection status detection module stores programs operated by the processing device of the computer system to monitor the connection status between the scanner and the computer system. Real-time information downloading module stores programs operated by the processing device of the computer system to download e-mail address books or fax number books to the scanner. Associated operations may thus be activated when the processing device of the computer system operates the aforementioned programs.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A depicts a connection diagram between a scanner and a computer system in the embodiment;

FIG. 1B depicts a fax number list shown on the display of the scanner;

FIG. 2 depicts a flowchart for representing the operating sequences of the embodiment;

FIG. 3 depicts a diagram illustrative of the module configuration of the embodiment; and

FIG. 4 depicts an exemplary diagram of the user interface shown on the display of the computer system in the embodiment.

### DESCRIPTION OF THE PREFERRED EMBODIMENT

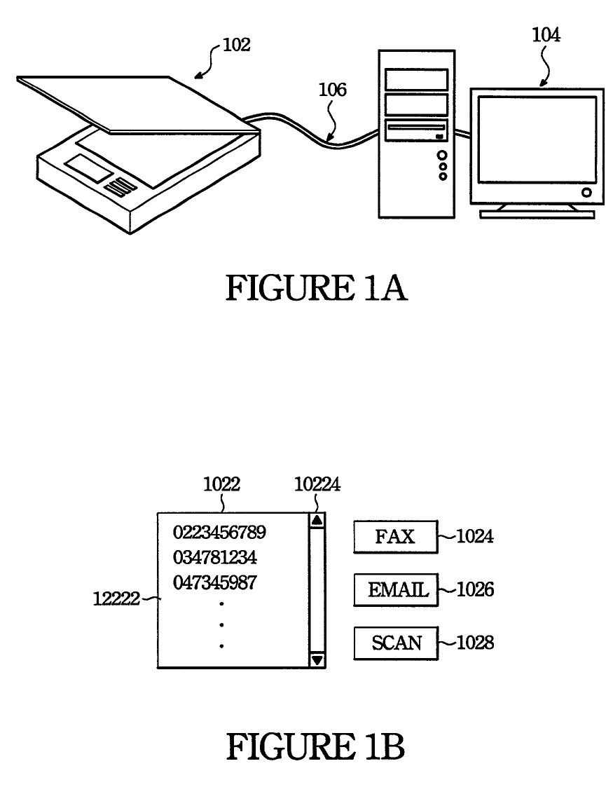

Please firstly refer to FIG. 1A, a connection diagram between a scanner 102 and a computer system 104 according to the invention is shown therein, wherein a connection 16 is employed to connect them for information transference. Notably, the communications between scanner 102 and computer system 104 are employed for giving explanations to the preferred embodiment. However, any peripheral device or even an information appliance that can communicate with computer system 104 may employ the embodiment to download and display real-time information from computer system 104, whereas an individual may give further indications by referring to all shown information. Additionally, any type of connection or communication interface, such as TWAIN, SCSI, EPP (Enhanced parallel port), or even USB (Universal serial bus) employed conventionally may be used to establish the connection 106 of the embodiment.

If the scanner 102 has to connect with computer system 104, the computer system 104 will detect the status of the scanner 102 and then establish connection 106 when scanner 102 normally works. Additionally, computer system 104 transfers commands or real-time information to scanner 102, whereas scanner 102 shows information on its display as references for an individual to determine his/her following operations. Real-time information may include e-mail address book or fax number books as different applications. Individual may select one from the shown e-mail address books or fax number books and to activate associated e-mail or faxing operations. In the following, scanner 102 forwards scanned images to computer system 104 for manipulations according to indications of individual. Liquid crystal display (LCD) conventionally employed may be mounted in scanner 102 for showing the downloaded e-mail address books or fax number books. Additionally, an individual may employ scrolls shown in LCD (e.g., shown on the rightmost side of LCD) or buttons for up-and down- scrolling accompanied with LCD to adjust contents shown in LCD.

FIG. 1B depicts an exemplary diagram for showing a fax number list after scanner 102 accepting the fax number books according to the embodiment. An individual may select a fax number from the shown list 12222 in LCD 1022 before pressing FAX button 1024 for activating associated facsimile operations. If an e-mail address list is shown, the individual may select an e-mail address before pressing EMAIL button 1026. Scanner 102 may forward derived scanned images to computer system 104 via connection 106 for activating e-mail manipulations indicated by individual. Additionally, all scanned images will be delivered to and stored in computer system 104 if an individual presses SCAN button 1028. Please note that the exemplary diagram shown in FIGURE 1B is only for explanation purpose, an ordinary person who is skilled in the art of the invention should modify the embodiment such as varying the amounts of employed buttons as applications. However, the real-time downloaded information from computer system 104 may simultaneously include both e-mail address books and fax number books. An individual may select one from the shown lists and then activate associated operations. The skilled persons may modify the embodiment as specifications or requirements.

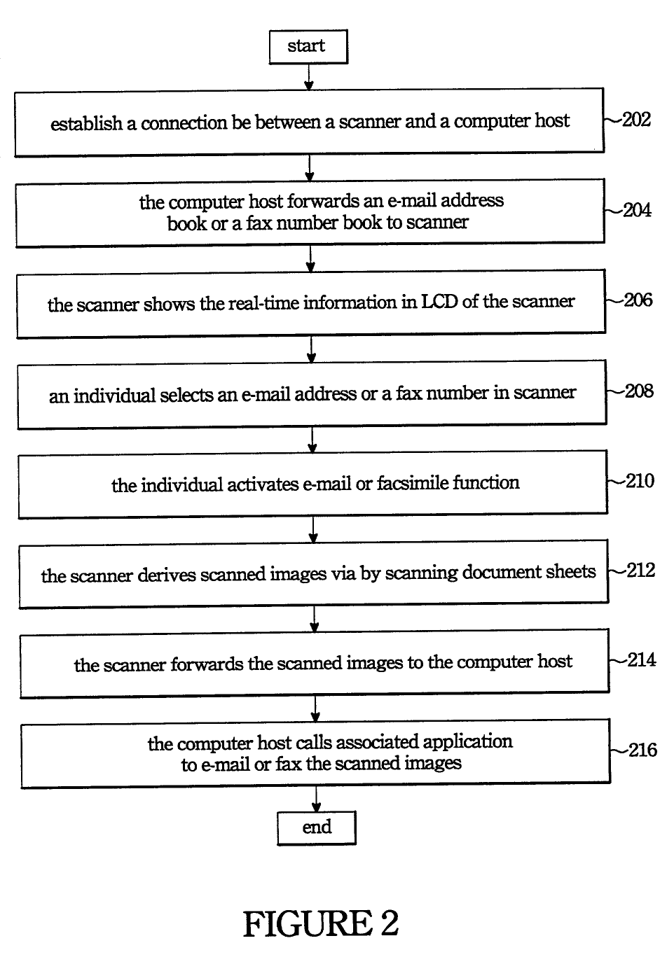

Please now refer to FIG. 2, a flowchart for illustrating the operating sequences is shown therein. As noted, all operating sequences in FIG. 2 are used for explanations to the interactions between scanner 102 and computer system 104. Any computer peripheral device or information appliance that may download and real-time display information from computer system 104 may apply the embodiment while establishment. When connection 106 between scanner 102 and computer system 104 is successfully established (step 202), computer system 104 delivers e-mail address books or fax number books to scanner 102 (step 204). Scanner 102 accepts the downloaded books and shows in LCD 1022 (step 204), whereas an individual may select one form the shown e-mail addresses or fax numbers (step 208). Next, an individual may press EMAIL button 1026 or FAX button 1024 to respectively activate e-mailing or facsimile operations when he/she completes selections (step 210). Scanner 102 then activates scan operations to derive scanned images by scanning document sheets (step 212), while scanned images are forwarded to computer system 104 for further manipulations (step 214). Computer system 104 activates associated applications to e-mail or fax the scanned images to destinations indicated by the individual in scanner 102 (step 216). Please note that an individual only has to turn scanner 102 power on and make the scanner 102 successfully connect with the computer system 104, he/she may then select an e-mail address or a fax number in scanner LCD before activating associated operations. A friendly user interface is provided to achieve the requirements for the information appliances.

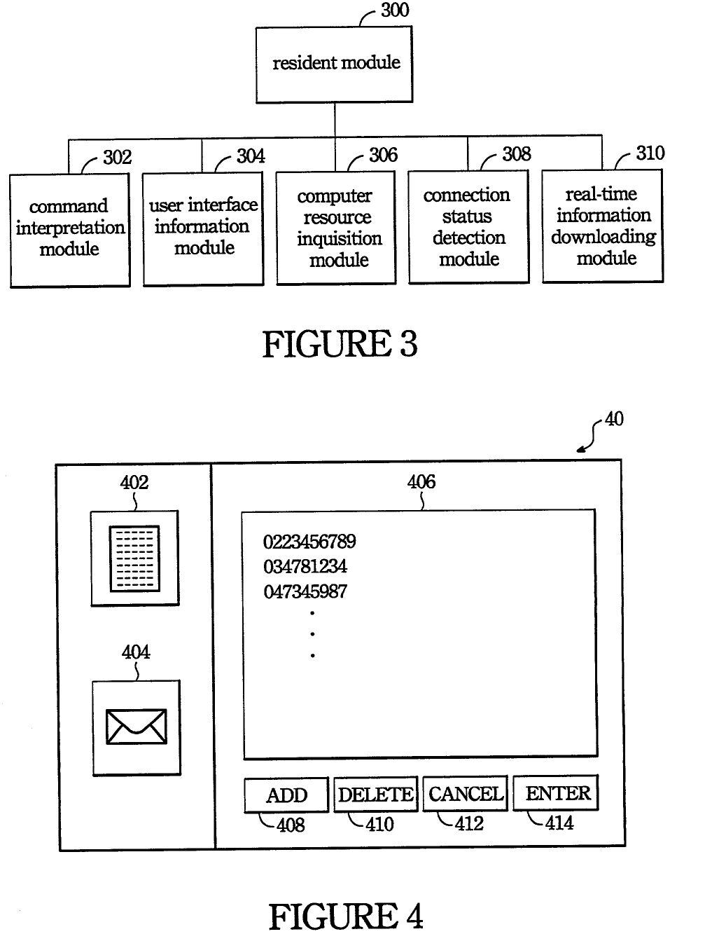

As noted, computer system 104 will detect the status of the scanner 102 after scanner 102 being turned on and connected with computer system 104 via connection 106 in step 202. Only when scanner 102 is normal, the flow of FIG. 2 is then started in the embodiment. Additionally, computer system 104 may download currently stored e-mail address books or fax number books to scanner 102, which indicates that different information may be downloaded to scanner 102 in every information transference. The purpose of downloading and displaying real-time information to an individual is achieved in the embodiment. Moreover, the indications of the individual may be simultaneously forwarded to computer system 104 for further manipulations when scanner 102 forwards scanned images to computer system 104. In practice, any software or application that provides functions for faxing or e-mailing, e.g., WinFax or Outlook, may be mounted and activated in computer system 104 of the embodiment. Please next refer to FIG. 3, an exemplary diagram for representing module configuration of the embodiment is shown therein, which encompasses programs of resident module or engine of scanner 102. Resident module 300 of scanner 102 basically encompasses a command interpretation module 302, a user interface information module 304, a computer resource inquisition module 306, a connection status detection module 308, and a real-time information downloading module 310. The command interpretation module 302 stores programs operated by the processing device of the computer system 104 to interpret commands, such as commands indicative of faxing or e-mailing scanned images, given by the individual from the scanner 102 or the computer system 104. The user interface information module 304 stores resource codes for associated graphic interfaces, such as codes for indicating graphics or icons, when the individual activates interfaces in the computer system 104. Computer resource inquisition module 306 stores programs operated by the processing device of computer system 104 to inquire currently mounted applications (such as WinFax or Outlook). Connection status detection module 308 stores programs operated by the processing device of computer system 104 to monitor the connection status between scanner 102 and computer system 104. Real-time information downloading module 310 stores programs operated by the processing device of computer system 104 to download e-mail address books or fax address books to scanner 102. Associated operations may thus be activated when the processing device of computer system 104 operates the aforementioned programs. As noted, the aforementioned modules may be stored in a computer-readable medium, e.g., portable medium including a compact disc, a floppy disk, or a magnetic optical (MO) disk, and accessed by the processing device of the computer system 104 by means of associated interfaces. However, those programs may be loaded to store in memory or hard disks of computer system 104, so that the processing device may access the programs to activate associated operations.

An individual may employ graphic interfaces provided by resident module 300, which are shown on computer system 104, to vary contents of the e-mail address books or fax number books that are downloaded to scanner 102. FIG. 4 depicts an exemplary diagram illustrative of the graphic interfaces provided by resident module 300 for an individual to vary the contents aforementioned. Several buttons, such as a facsimile setting button 402 for varying settings associated with facsimile functions, an e-mail setting button 404 for varying settings associated with e-mail functions, while the contents of the selected setting button are shown in display area 406. If an individual wants to increase or delete an e-mail address or a fax number shown in display area 406, he/she may press an ADD button 408 or a DELETE button 410 for achieve his/her requirements, respectively. However, if he/she wants to confirm or cancel the designated operations, he/she may employ the ENTER button 414 or CANCEL button 416 to achieve his/her desires. Please note that the shown graphic interface in FIG. 4 is only for explanation purpose, an ordinary person who is skilled in the art of the invention should modify the embodiment as specifications or applications.

In conclusion, a peripheral device may employ the system and method disclosed in the embodiment to display real-time information from a computer system after successful connection. An individual may determine consecutive operations by referring to the shown information by means of friendly interfaces provided by the embodiment so that the disadvantages of complex operating sequences and user interfaces can be eliminated.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for communication between a computer system and a peripheral device, said communication method comprising the steps of:
establishing a connection between said peripheral device and said computer system;
transferring real-time information from said computer system to said peripheral device;
displaying said real-time information in said peripheral device;
activating a function in said peripheral device wherein said activated function is indicative of a selected one of said real-time information;
forwarding information associated with said activated function to said computer system; and
activating an application associated with said activated function to perform said function.

2. The communication method according to claim 1, wherein said establishing step comprising a step of detecting whether said peripheral device works normally.

3. The communication method according to claim 1, wherein said peripheral device is an information appliance or a scanner.

4. The communication method according to claim 3, wherein said real-time information comprises an e-mail address book or a fax number book.

5. The communication method according to claim 4, wherein said selected one of said real-time information is an e-mail address, a scanned image generated by said scanner being included in said associated information for forwarding to said computer system, wherein said computer system e-mail said scanned image to said selected e-mail address.

6. The communication method according to claim 4, wherein said selected one of said real-time information is an fax number, a scanned image generated by said scanner being included in said associated information for forwarding to said computer system, wherein said computer system fax said scanned image to said selected fax number.

7. The communication method according to claim 1, further comprising a step of varying said real-time information by means of graphic interfaces shown in said computer system.

8. A computer-readable storage medium for storing a communication method between a computer system and a peripheral device, said computer-readable medium comprising:
a real-time information downloading module for storing programs operated by a processing device of said computer system to transfer said real-time information from said computer system to said peripheral device, wherein said real-time information is shown in said peripheral device;
a command interpretation module for storing programs operated by said processing device of said computer system to interpret a command input from said peripheral device or said computer system, wherein said command input from said peripheral device indicates a function, said command input from said peripheral device is forwarded to said computer system for performing said indicated function, wherein said command input from said peripheral device comprises at least one selected from said real-time information;
a user interface information module for storing resource codes of graphic interfaces shown in said computer system; and
a computer resource inquisition module for storing programs operated by said processing device to inquire currently mounted applications of said computer system.

9. The computer-readable storage medium according to claim 8, further comprising a connection status detection module for storing programs operated by said processing device to monitor a connection status between said computer system and said peripheral device.

10. The computer-readable storage medium according to claim 8, wherein said peripheral device is an information appliance or a scanner.

11. The computer-readable storage medium according to claim 10, wherein said real-time information comprises an e-mail address book or a fax number book.

12. The computer-readable storage medium according to claim 11, wherein said selected one of said real-time information is an e-mail address, a scanned image generated by said scanner being included in said associated information for forwarding to said computer system, wherein said computer system e-mail said scanned image to said selected e-mail address.

13. The computer-readable storage medium according to claim 11, wherein said selected one of said real-time information is an fax number, a scanned image generated by said scanner being included in said associated information for forwarding to said computer system, wherein said computer system fax said scanned image to said selected fax number.

14. The computer-readable storage medium according to claim 8, further comprising a step of varying said real-time information by means of graphic interfaces shown in said computer system.

15. A computer system for providing real-time information for a peripheral device, and for performing a function indicated from said peripheral device, said computer system comprising:
a storage device;
a processing device coupled with said storage device for operating programs stored in said storage device to
download said real-time information to said peripheral device, said real-time information being shown in said peripheral device;
receive a command input from said peripheral device, said command input from said peripheral device comprising a selected one from said real-time information;
perform a function indicated by said command input from said peripheral device, wherein said function is performed to a selected one from said real-time information; and
activate an application according to said function for performing said function in said computer system.

16. The computer system according to claim 15, wherein said processing device operated said programs stored in said storage device to shown a graphic interface for receive a command input from said computer system, said command input from said computer system comprising a command for varying said real-time information.

17. The computer system according to claim 15, wherein said processing device operated said programs stored in said storage device to monitor a connection status between said computer system and said peripheral device.

18. The computer system according to claim 15, wherein said real-time information comprises an e-mail address book or a fax number book.

19. The computer system according to claim 18, wherein said selected one of said realtime information is an e-mail address, a scanned image generated by said scanner being included in said associated information for forwarding to said computer system, wherein said computer system e-mail said scanned image to said selected e-mail address.

20. The computer system according to claim 18, wherein said selected one of said realtime information is an fax number, a scanned image generated by said scanner being included in said associated information for forwarding to said computer system, wherein said computer system fax said scanned image to said selected fax number.
